(19) United States
(12) Patent Application Publication
(10) Pub. No.: US 2010/0263386 A1
(43) Pub. Date: Oct. 21, 2010

(54) TURBINE ENGINE HAVING A LINER

(75) Inventors: Kara Johnston Edwards, Greer, SC (US); Thomas Edward Johnson, Greer, SC (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/425,229

(22) Filed: Apr. 16, 2009

(51) Int. Cl. F02C 7/20; F02C 1/00

(52) U.S. Cl. 60/796; 60/752

(57) ABSTRACT

In one embodiment, a combustor of a turbine system may include a liner disposed inside the combustor. The lining element may include a heat shield having a mounting stud extending along an axis and a shell having an inner surface oriented towards the heat shield. The shell may include a passage configured to receive the mounting stud, and the mounting stud may include a structure configured to hold the heat shield apart from the inner surface of the shell along the axis of the mounting stud.

### BACKGROUND OF THE INVENTION

The subject matter disclosed herein relates to gas turbine engines, and more specifically, to heat shields associated with combustors.

In general, gas turbine engines combust a mixture of compressed air and fuel to produce hot combustion gases. For example, a set of fuel nozzles may inject air and fuel, such as propane, natural gas, or jet fuel, into a combustor. As appreciated, gas turbine engines include a variety of cooling systems to protect components from the heat of combustion. These cooling systems may include coolant paths and/or heat shields. Unfortunately, the coolant path may not adequately cool all areas of the gas turbine engine. For example, hot spots may exist in certain components.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment a turbine system may include a turbine, a compressor; a combustor; and a liner disposed inside the combustor. The liner may include a heat shield comprising a mounting stud extending along an axis; a shell comprising an inner surface oriented towards the heat shield, wherein the shell comprises a passage configured to receive the mounting stud; and a structure disposed on the mounting stud, wherein the structure is configured to hold the heat shield apart a distance from the inner surface of the shell along the axis of the mounting stud.

In another embodiment, a lining assembly for a combustor may include a heat shield comprising a plurality of mounting studs; a support structure including an inner surface oriented towards the heat shield, wherein the support structure includes a plurality of passages configured to receive the mounting studs; and a standoff structure extending outwardly from each mounting stud, wherein the standoff structure is spaced apart from the inner surface of the support structure along an axis of the mounting stud.

In another embodiment, a turbine system may include a heat shield. The heat shield may include a mounting stud extending from the heat shield along an axis; and a standoff structure disposed on the mounting stud, wherein at least a portion of the standoff structure is substantially orthogonal to the axis.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system having a fuel nozzle coupled to a combustor in accordance with an embodiment of the present technique;

FIG. 2 is a cutaway side view of the combustor, as shown in FIG. 1, with a plurality of fuel nozzles coupled to an end cover in accordance with an embodiment of the present technique;

FIG. 3 is a partial side view of the combustor, taken within line 3-3 as shown in FIG. 2, with a combustor liner with standoff portions integrated onto mounting studs of a heat shield, in accordance with an embodiment of the present technique;

FIG. 4 is a partial perspective view of an exemplary heat shield with a mounting stud including a standoff portion in accordance with an embodiment of the present technique;

FIG. 5 is a partial sectional view of an exemplary embodiment of a curved combustor liner, such as one taken along line 5-5 shown in FIG. 2, including a curved support shell and a curved heat shield with a plurality of mounting studs including curved standoff portions in accordance with an embodiment of the present technique;

FIG. 6 is a partial perspective view of an alternative heat shield with an asymmetrical racetrack-shaped standoff portion in accordance with an embodiment of the present technique;

FIG. 7 is top view of a liner assembly with an asymmetrical standoff portion of FIG. 6 in accordance with an embodiment of the present technique; and

FIG. 8 is a perspective view of a combustor cap assembly with a heat shield affixed to an end plate in accordance with an embodiment of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, various embodiments of combustor liners may be employed to improve the performance of a turbine engine system. A turbine engine system may include one or more combustors, such as annular can combustors. A turbine engine combustor may include a generally cylindrical casing having a longitudinal axis, the casing having fore and aft sections secured to each other, and the casing as a whole secured to the turbine casing. Each combustor also includes a flow sleeve, and a combustor liner substantially concentrically arranged within the flow sleeve. Both the flow sleeve and combustor liner extend between the transition piece at their downstream ends, and a combustor cap assembly (located within an upstream portion of the combustor) at their upstream ends. The flow sleeve is attached directly to the combustor casing, while the cap assembly supports the liner. The cap assembly is fixed to the combustor casing.

In embodiments, the combustor liner, including the cap, may be a multiple layer structure that may include a first layer of one or more heat shields arranged on the “hot” side of a second layer, a shell portion of the liner. The heat shield may protect the shell from the heat of the combustion chamber to extend the life of the liner, which may be expensive and/or complicated to replace. The heat shield may be affixed to the shell via a plurality of mounting studs that are configured to be received in corresponding passages on the combustor liner and cap assembly.

In certain arrangements in which the heat shield is affixed to the shell of the combustor liner, a small space provided between the shell and the heat shield may allow cooling air to flow into the space, which may slow heat transfer to the combustor liner. However, despite the cooling effects of the space between the liner and the heat shield, certain problems may be associated with such arrangements. Providing precise alignment of the heat shield along the combustor liner may be complex. For example, if the distance between the liner and the heat shield varies along the length of the combustor liner, the cooling effects will vary as a result, which may lead to thermal gradients and/or individual hot spots on portions of the combustor liner that may decrease its lifespan. In other arrangements, a heat shield may include pins or collars oriented towards the shell to hold the heat shield at a predetermined distance from the shell of the combustor liner. However, these arrangements may also contribute to the formation of thermal gradients, which may decrease the life of the components.

In certain embodiments, as discussed in detail below, a heat shield may include a mounting stud with a standoff structure configured to hold or align the heat shield such that a substantially uniform gap between the shell of the combustor liner and the heat shield is achieved. The standoff structure of the present embodiments may be incorporated onto a mounting stud for the heat shield to provide the advantage of improved cooling of the combustor liner by reducing the barriers to air flow in the gap. Further, by providing clear airflow around the mounting stud, the formation of hot spots in or on the mounting stud may be reduced, which may improve the lifespan of the heat shield and the combustor liner in general. Accordingly, in certain embodiments, the heat shield may have no additional elements extending from the face of the heat shield apart from the mounting studs with incorporated standoff structures. In such embodiments, the surface of the heat shield facing the shell may be substantially planar or smooth between the mounting studs.

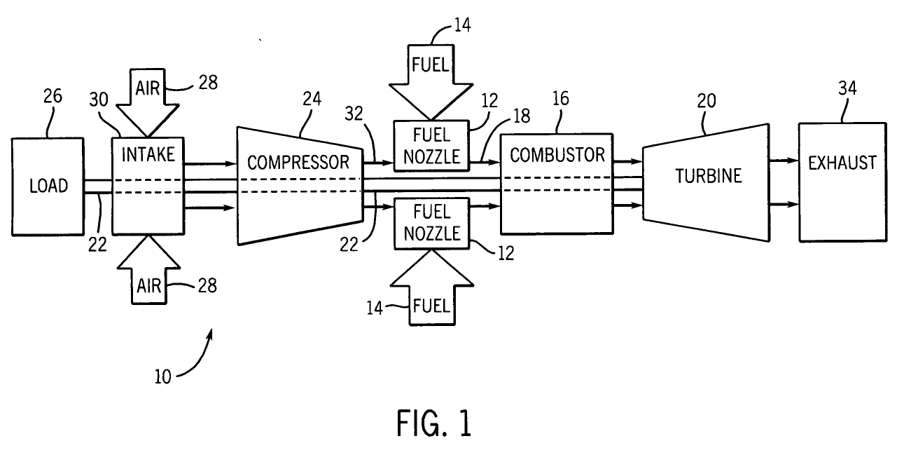

Turning now to the drawings and referring first to FIG. 1, a block diagram of an embodiment of a turbine system 10 is illustrated. The diagram includes fuel nozzles 12, a fuel supply 14, and combustor 16. As depicted, fuel supply 14 routes a liquid fuel or gas fuel, such as natural gas, to the turbine system 10 through a fuel nozzle 12 into the combustor 16. After mixing with pressurized air, shown by arrow 18, ignition occurs in the combustor 16 and the resultant exhaust gas causes blades within turbine 20 to rotate. The coupling between blades in turbine 20 and shaft 22 will cause rotation of shaft 22, which is also coupled to several components throughout the turbine system 10, as illustrated. For example, the illustrated shaft 22 is drivingly coupled to a compressor 24 and a load 26. As appreciated, load 26 may be any suitable device that may generate power via the rotational output of turbine system 10, such as a power generation plant or a vehicle.

Air supply 28 may route air via conduits to air intake 30, which then routes the air into compressor 24. Compressor 24 includes a plurality of blades drivingly coupled to shaft 22, thereby compressing air from air intake 30 and routing it to fuel nozzles 12 and combustor 16, as indicated by arrows 32. Fuel nozzle 12 may then mix the pressurized air and fuel, shown by numeral 18, to produce an optimal mix ratio for combustion, e.g., a combustion that causes the fuel to more completely burn so as not to waste fuel or cause excess emissions. After passing through turbine 20, the exhaust gases exit the system at exhaust outlet 34. As discussed in detail below, an embodiment of turbine system 10 includes certain combustor liner structures and arrangements. For example, the liner structures may include a two-layer combustion liner 44 with a space between the layers. The layers may be spaced apart via one or more structures on a heat shield layer of the combustor liner 44.

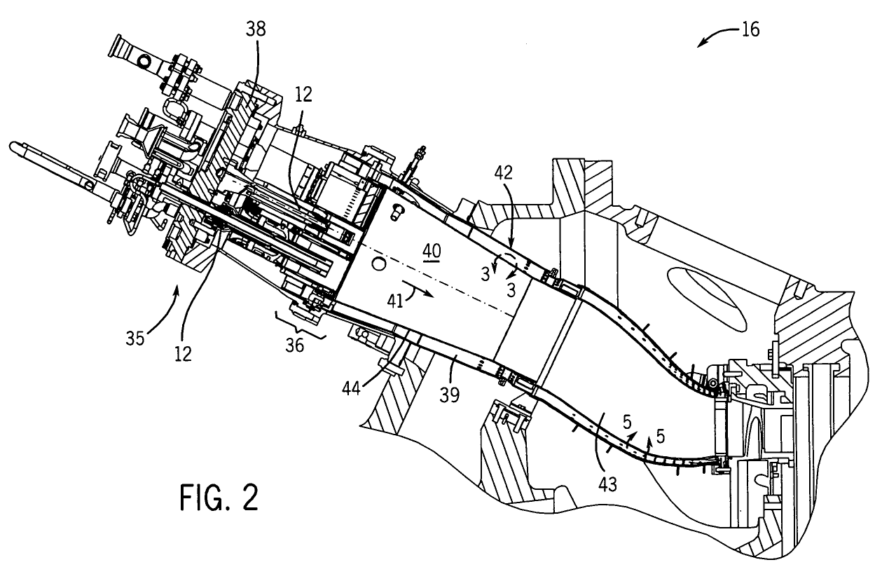

FIG. 2 shows a cutaway side view of an embodiment of combustor 16 having a plurality of fuel nozzles 12. In certain embodiments, a head end 35 of a combustor 16 includes an end cover 38. Cap assembly 36 closes off the combustion chamber 40 and houses the fuel nozzles 12, which route fuel, air and other fluids to the combustor 16. For example, the combustor cap assembly 36 receives one or more fuel nozzle assemblies and pressurized gas to each fuel nozzle 12. Each fuel nozzle 12 facilitates mixture of pressurized air and fuel into a combustion chamber 40 of the combustor 16. The air fuel mixture then combusts in the combustor 16, thereby creating hot pressurized exhaust gases, which drive the rotation of blades within turbine 20. Combustor 16 includes a flow sleeve 42 and a combustor liner 44 forming the combustion chamber 40. In certain embodiments, flow sleeve 42 and lining 44 are coaxial or concentric with one another to define a hollow annular space 39, which may enable passage of air for cooling and entry into the combustion zone 40. For example, air may flow through perforations in sleeve 42 into the hollow annular space 39 and flow downstream toward end 36, into fuel nozzles 12, through flow conditioners, and then downstream into the combustion chamber 40 through fuel nozzles 12. By further example, air may flow into the combustion chamber through perforations in sleeve 42 and in one or more layers of liner 44. Liner 44 also may be designed to control the flow and speed of the air fuel mixture and hot exhaust gases upstream in direction 41 toward head end 35. In addition, liner 44 may be adapted to interface with a heat shield, discussed in more detail below. In one embodiment, the liner assembly 44 may be used instead of a flow sleeve 42. In other words, a flow sleeve 42 may not be used.

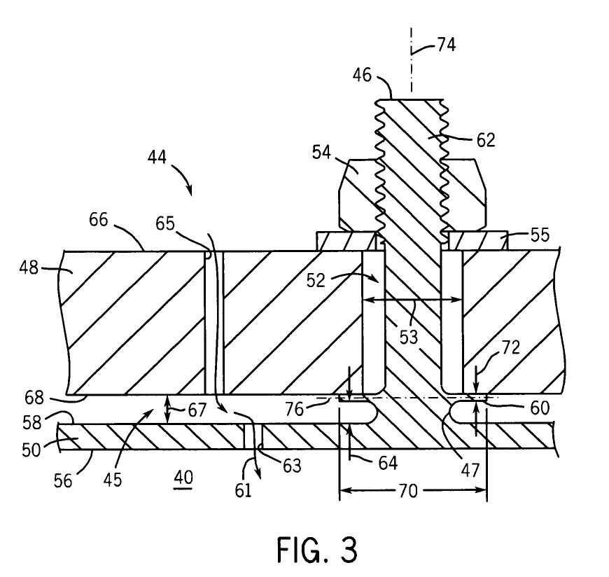

Referring to FIG. 3 is a side view of an embodiment of the combustor liner 44 having a mounting stud 46, a support shell 48 and a heat shield 50. The support shell 48 may, in embodiments, support any suitable number of axially and circumferentially distributed heat shields 50, which may take the form of panels or segments generally shaped to follow the contours of the shell 48. For example, a plurality of segments may be circumferentially arranged to define a full circle around the combustion chamber 40. By further example, a plurality of segments may be arranged one after another in the axial direction, e.g., in downstream direction 41. A plurality of threaded mounting studs 46 may project from one side of each heat shield 50 and penetrate through passages 52 in the shell 48. A passage 52 may have a given opening dimension 53 (e.g., a diameter or other dimension) large enough to accommodate the mounting stud 46. A nut 54 and a washer 55 are threaded onto each stud 46 secures each heat shield 50 to the support shell 48, so that the heat shield 50 is substantially parallel to the shell 48. When thus assembled, one side of the heat shield 50, referred to as the hot side 56, faces the combustion chamber 40. The other side, referred to as the cold side 58, faces the support shell 48. In one embodiment, perforations 65 and 63 in the support shell 48 and the heat shield 50, respectively, allow cooling air to follow cooling path 61.

As shown, the mounting studs 46 may include a standoff portion 60 disposed along a base 47 of the mounting stud 46 a distance 64 from the cold side 58. The standoff portion 60 is generally sized and shaped to stop the movement of the mounting stud 46 orthogonally through passage 52. Such a configuration blocks the heat shield 50 from being pulled closer than a predetermined distance 67 from the support shell 48. After the nut 54 and washer 55 are applied to a threaded distal end 62 of the mounting stud 46, the heat shield 50 is spaced radially apart from support shell 48 by the distance 67. In embodiments, the distance 67 between heat shield 50 and support shell 48 is approximately the distance 64 plus the thickness of the standoff portion 60. The standoff portion 60 of the mounting stud 46 may be any suitable size or shape to halt movement of the mounting stud 46. In embodiments, the standoff portion 60 and the mounting stud 46 may be the only structures to extend from the surface 58 of the heat shield 50. Accordingly, there may be no intervening structures between the surface 58 and the edges of the standoff portion 60 that extend orthogonally from the mounting stud 46. In other words, the surface 58 may extend directly, without interruption, to the base 47 of the mounting stud 46. Thus, a coolant flow (e.g. air flow) may cool the heat shield 50 along the entire surface 58 directly to the base 47 without interruption, for improved cooling. Thus, the standoff portion 60 provides the desired distance 67 between the support shell 48 and the heat shield 50 with a reduced possibility for hot spots near the studs 46.

The mounting studs 46 may be unitary, e.g., cast with the heat shield 50 or may be non-integrally formed, such as by press fitting of the mounting stud 46 into the heat shield 50, or may be otherwise secured relative to the heat shield 50. The mounting studs 46 are sufficiently long such that threaded distal ends 62 extend beyond the shell 48. The nuts 54 and washers 55 engage the shell exterior surface 66 while an interior shell surface 68 faces the cold side 58 of the heat shield 50. In embodiments, the support shell 48 and heat shields 50 may be metal, such as a nickel alloy, although not necessarily the same metal. In certain combustors 16, one or more of the heat shields 50 may include a suitable refractory material, e.g., a ceramic material, as part of a body or a coating of the heat shield 50.

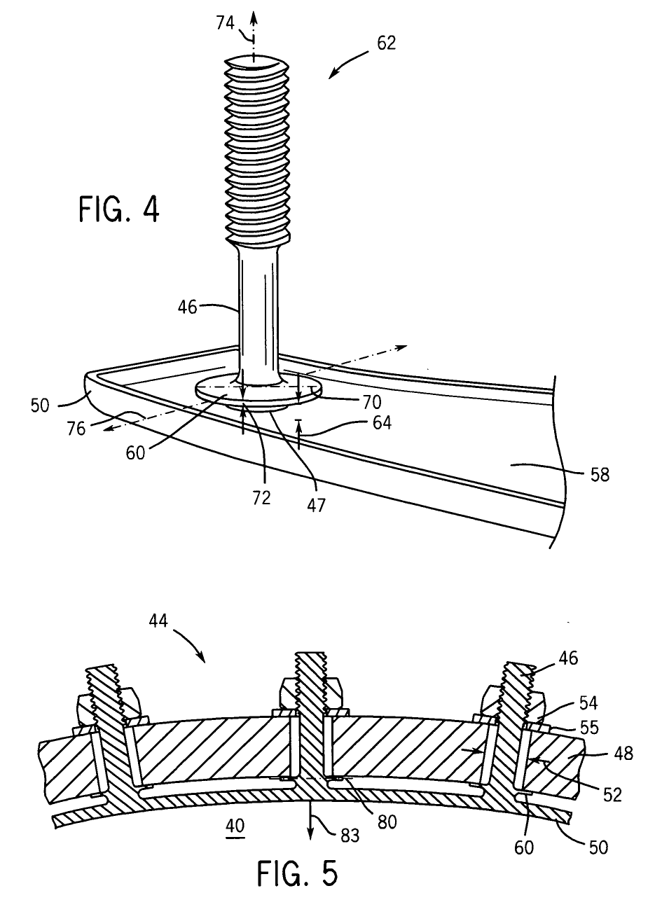

FIG. 4 is a perspective view of an exemplary heat shield 50. The standoff portion 60 is shown as generally disc-shaped in a plane 76 substantially orthogonal to the axis 74 of the mounting stud 46. In such an embodiment, a diameter 70 of the standoff portion may be at least larger than the opening dimension 53 of passage 52 (see FIG. 3) in support shell 48. As such, the heat shield 50 may be affixed or mounted to the support shell 48 by passing one or more mounting studs 46 through passages 52 until the standoff portion 60 contacts the inner surface 68 of the inner shell 48. The larger diameter 70 prevents further movement of the mounting stud 46 through passage 52. In other embodiments, the standoff portion 60 may be generally bar-shaped, race-track shaped, oval, or irregularly shaped, so long as at least one dimension of the offset portion 60 is greater than the opening dimension 53 in the plane 76. In embodiments, at least one dimension of the offset portion 60 in plane 76 is at least about 10, 20, 30, 40, 50, 60, 70, 80, 90, 100, or 200 percent greater than opening dimension 53. In other embodiments, at least one dimension of the offset portion 60 in plane 76 is about 10 to about 20, about 20 to about 30, about 30 to about 40, about 40 to about 50, about 50 to about 60, about 60 to about 70, about 70 to about 80, about 80 to about 90, about 90 to about 100, or about 100 to about 200 percent greater than opening dimension 53.

Further, in embodiments, a standoff portion 60 may be generally flat or disposed along plane 76 such that its dimension 72, e.g., thickness, along axis 74 is minimized. This may provide the advantage of maximizing the flow in the space 45 (see FIG. 3) between the heat shield 50 and the support shell 48. By reducing the profile of the standoff portion 60, barriers to cooling air flow are minimized. Further, by clearing a general area around the base 47 of the mounting stud 46, the base 47 may be more efficiently cooled. Because the base 47 of the mounting stud 46 acts as an air flow barrier, the mounting stud 46 may be particularly sensitive to experiencing a thermal gradient. An arrangement in which dimension 72 is minimized may allow more efficient cooling of the base 47. In embodiments, the dimension 72 along axis 74 is less than about 60, 50, 40, 30, 20, or 10 percent of the total distance 67 between the heat shield 50 and the shell 48. In other embodiments, the dimension 72 along axis 74 is between about 10 to about 20, about 20 to about 30, about 30 to about 40, about 40 to about 50, about 50 to about 60 percent of the total distance 67.

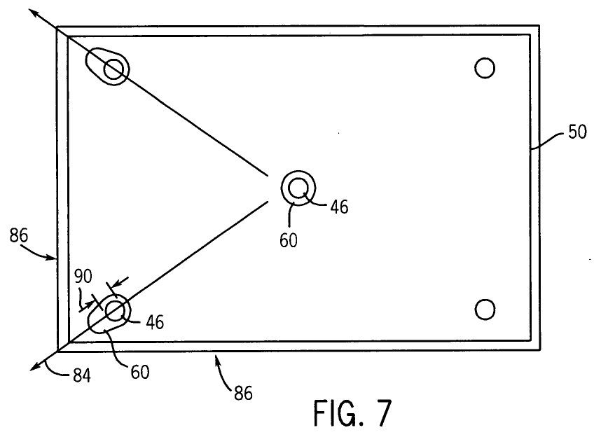

FIG. 5 depicts a partial sectional view taken along line 5-5 of FIG. 2 of the combustor liner 44 with the heat shield 50 mounted to the support shell 48 by a plurality of mounting studs 46 with curved standoff portions 60. In the depicted arrangement, the combustor liner 44 is configured to follow the contours of a generally can-shaped combustion chamber 40, such as a combustion chamber 40 in an annular can combustor. Accordingly, certain portions of the liner 44 may be curved to accommodate the can shape. In such an embodiment, the standoff portions 60 may be generally curved to follow the contours of the support shell 48. The curve path 80 of the standoff portions 60 may be substantially flat, concave or convex, depending of the curvature of the support shell 48. In addition, also shown are potential pull directions 83, or directions of thermal growth for the heat shield 50 and support shell 48. For example, the mounting stud 46 may grow in a direction 84 (see FIG. 7) while the base layer of the heat shield 50 may also expand. The standoff portions 60 may provide improved sealing of the stud passages 52 in the support shell 48 relative to generally straight standoff portions 60.

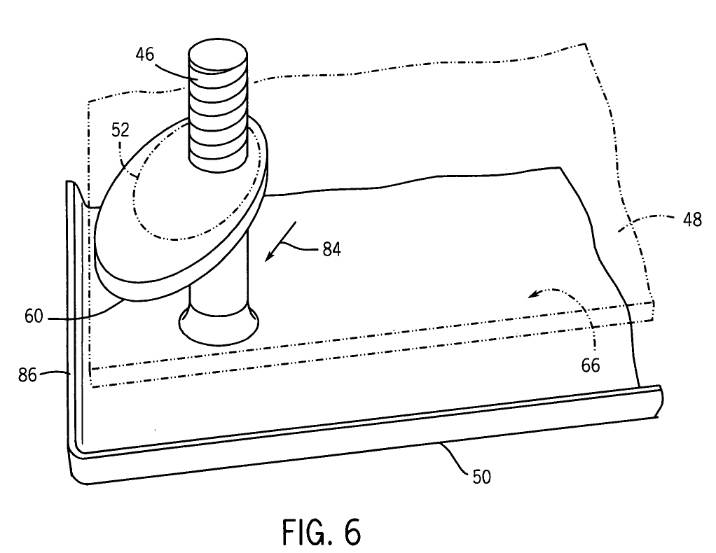

In embodiments, an asymmetrical standoff portion 60 may be configured to interface with asymmetrical passages 52 in the support shell 48 to account for the thermal expansion of the heat shield 50 or for assembly and disassembly. For example, as shown in perspective view in FIG. 6, a racetrack-shaped standoff portion 60 may be configured to be oriented in a direction 84 of predicted thermal expansion for the mounting stud 46. In embodiments in which the combustor 16 is operating under high temperatures, the support shell 48 and/or the heat shield 50 may undergo some thermal expansion. In embodiments, the expansion may be generally towards nearest edge 86.

The orientation of standoff portion 60 may take the form of an asymmetrical shape along the plane 76. In embodiments, the standoff portion 60 may be asymmetrical about mounting stud 46, using the axis 74 of mounting stud 46 as an axis of rotational symmetry. The standoff portion 60 may have a greater percentage of volume or surface area in the direction of thermal expansion 84. In embodiments, the standoff portion 60 may have more than about 50, 55, 60, 65, 70, 75, 80, 85, 90, or 95 percent of its volume or surface area in one 180° portion of a given radial area around axis 74. In other embodiments, the standoff portion 60 may have more than about 60% of its volume or surface area, more than about 75% of its volume or surface area, more than about 80% of its volume or surface area, or more than about 90% of its volume or surface area in one 180° portion of the radial area around axis 74. In embodiments, the volume or surface area in one 180° portion of the area around axis 74 is between about 55% to about 70% or between about 75% to about 90%.

In an embodiment of a combustor liner 44 shown in top view in FIG. 7 looking down on heat shield 50, the standoff portions 60 may have different orientations along the heat shield 50, depending on the predicted direction 84 of thermal expansion in a given area of the heat shield 50. For example, the standoff portions 60 may be generally oriented in the direction of thermal growth 84, which, in one embodiments, may be towards the nearest edge 86, while a mounting stud 46 generally in the center of the heat shield 50 may not have an irregularly-shaped standoff portion 60 or receiving passage 52 (situated on the support shell 48, not shown). However, for mounting studs located near an edge 86 of the heat shield, providing a standoff portion 60 that is relatively racetrack-shaped may allow the expansion of the standoff portion without compromising the seal. In addition, the passage 52 on the shell 48 (not shown) may also be racetrack-shaped to allow for thermal expansion of the heat shield 50 that results in a movement of the stud 46 a distance 90 towards the edge. Because the expansion of the heat shield may change the shape or position of the mounting studs 46, for example the studs 46 may move farther apart from one another, the asymmetrical standoff portion 60 may be positioned to account for the predicted change in shape or position of the mounting studs 46 relative to the passages 52. As such, the standoff portion 60 may provide an improved seal to prevent cooling air from bypassing the cooling flow 67.

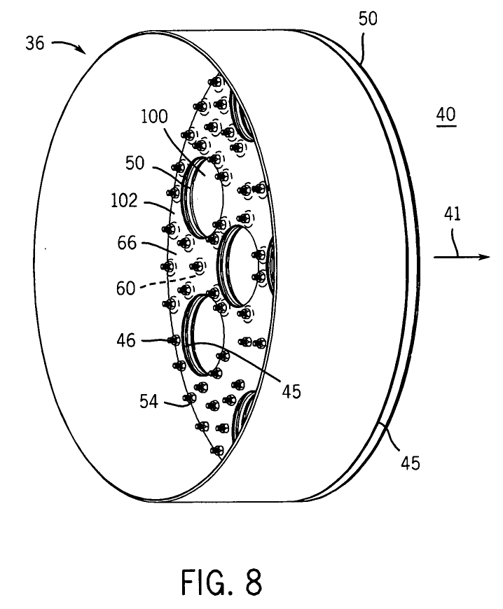

The disclosed embodiment of liner 44 may be incorporated into any portion of a turbine system 10 or any other system that may experience high temperatures. Accordingly, the liner assemblies 44 may be incorporated into an outer shroud of a combustor 16 or a combustor cap assembly 36, shown in perspective side view in FIG. 8. The combustor cap assembly 36 may include passages 100 for receiving fuel nozzles 12. As shown, the cap assembly 36 includes an outer end plate 102 and an inner heat shield 50. The heat shield 50 may include mounting studs 46 affixed with nuts 54 and washers 55 to the outer plate 102. The mounting studs 46 may include standoff portions 60 configured to provide gap 45 between the outer plate 102 and the heat shield 50. As shown, in embodiments, all or only some of the plurality of mounting studs 46 may include standoff portion 60. Such an embodiment may provide an advantage of decreased flow barriers in the gap 45. In embodiments, about 50% or more, about 60% or more, or about 100% of mounting studs 46 may include a standoff portion 60.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A turbine system, comprising:
a turbine;
a compressor;
a combustor; and
a liner disposed inside the combustor, comprising:
a heat shield comprising a mounting stud extending along an axis;
a shell comprising an inner surface oriented towards the heat shield, wherein the shell comprises a passage configured to receive the mounting stud; and
a structure disposed on the mounting stud, wherein the structure is configured to hold the heat shield apart a distance from the inner surface of the shell along the axis of the mounting stud.

2. The turbine system of claim 1, wherein the structure comprises a disc or a racetrack shape.

3. The turbine system of claim 2, wherein the disc is substantially orthogonal to the axis of the mounting stud.

4. The turbine system of claim 2, wherein the disc is substantially concave or convex relative to a plane substantially orthogonal to the axis of the mounting stud.

5. The turbine system of claim 1, wherein the mounting structure comprises at least one dimension larger than an opening dimension of the passage configured to receive the mounting stud.

6. The turbine system of claim 5, wherein the at least one dimension larger than the opening of the passage configured to receive the mounting stud is at least about 50% greater than the opening dimension of the passage.

7. The turbine system of claim 1, wherein the structure comprises rotational asymmetry relative to the axis of the mounting stud.

8. The turbine system of claim 7, wherein the passage configured to receive the mounting stud comprises rotational asymmetry relative to the axis of the mounting stud.

9. The turbine system of claim 7, wherein the structure is oriented in a direction of a nearest edge of the heat shield or away from the center of the heat shield.

10. The turbine system of claim 1, wherein the structure comprises a dimension along the axis of the mounting stud that is less than 50% of the distance between the heat shield and the shell.

11. A lining assembly for a combustor, comprising:
a heat shield comprising a plurality of mounting studs;
a support structure comprising an inner surface oriented towards the heat shield, wherein the support structure comprises a plurality of passages configured to receive the mounting studs; and
a standoff structure extending outwardly from each mounting stud, wherein the standoff structure is spaced apart from the inner surface of the heat shield by a distance along an axis of the mounting stud.

12. The turbine system of claim 11, wherein the standoff structure is generally sized and shaped to seal at least a portion of the passage receiving the mounting stud.

13. The turbine system of claim 11, wherein a surface of the heat shield is substantially smooth and uninterrupted between the mounting studs.

14. The turbine system of claim 11, wherein the lining assembly is part of a cap assembly for the combustor.

15. The turbine system of claim 11, wherein the support structure and the heat shield comprise one or more passages configured to receive a fuel nozzle.

16. The turbine system of claim 11, wherein the support structure is asymmetrical about an axis of the mounting stud.

17. The turbine system of claim 16, wherein the support structure comprises a racetrack-shaped disc.

18. A turbine system, comprising:
a heat shield comprising:
a mounting stud extending from the heat shield along an axis; and
a standoff structure disposed on the mounting stud, wherein at least a portion of the standoff structure is substantially orthogonal to the axis.

19. The turbine system of claim 18, wherein the standoff structure comprises a disc.

20. The turbine system of claim 18, wherein a surface of the heat shield is uninterrupted about the mounting stud, and the standoff structure is offset in a generally parallel orientation relative to the surface.
